(19) United States
(12) Patent Application Publication
(10) Pub. No.: US 2026/0269686 A1
(43) Pub. Date: Sep. 10, 2026

(54) OVERCHARGE PROTECTION DEVICE

(71) Applicant: Xinxin Xiao, Shaoyang (CN)

(72) Inventor: Xinxin Xiao, Shaoyang (CN)

(21) Appl. No.: 19/662,123

(22) Filed: Apr. 29, 2026

(51) Int. Cl. H02K 7/14; H02J 7/61; H02J 7/80

(52) U.S. Cl. CPC H02K 7/14; H02J 7/61; H02J 7/80

(57) ABSTRACT

Provided is an overcharge protection device, which includes a shell component including an accommodation chamber and a terminal outlet provided on the shell component; at least two through holes communicate with the accommodation chamber being provided on one side where the terminal outlet is located; a circuit board provided in the accommodation chamber, where the circuit board integrates with a charging circuit, a charging state detection circuit; an input terminal that is electrically connected to the circuit board and extends from the terminal outlet; and a separation mechanism including a motor, a screw, a nut slider, and at least one push rod, where the motor is limited or fixed in the accommodation chamber, the motor is electrically connected to the circuit board, the motor drives the screw to rotate, and the nut slider is caused to move in a straight line along the screw.

### TECHNICAL FIELD

The present disclosure relates to the field of charging technologies, and in particular, to an overcharge protection device.

### BACKGROUND

There are generally two ways of charging protection for the existing chargers. One is achieved through pure circuits, which rely on electronic components such as transistors, Metal Oxide Semiconductor Field Effect Transistor, (MOSFET)s, and comparators. Once they break down, fail, or lose control, the protection will directly fail, resulting in insufficient reliability; and it is difficult to detect after the fault occurs, with a high risk of hidden overcharging; unable to achieve a true “complete power outage”, there is still leakage current and static power consumption after the circuit is turned off. Another method is mechanical shutdown, which currently uses a current guided electromagnetic spring device to pop out and then power off and reset. This structure has uncontrollable popping force, which can easily cause damage to an object due to excessive force, thereby posing a safety hazard.

Given the above situation, it is necessary to provide a stable overcharge protection device.

In order to solve the technical issues, the present disclosure is implemented as follows: an overcharge protection device, including:

a shell component, which has an accommodation chamber inside, and a terminal outlet is further provided on the shell component, at least two through holes that communicate with the accommodation chamber are provided on one side where the terminal outlet is located;

a circuit board, which is provided inside the accommodation chamber, and integrated with a charging circuit and a charging state detection circuit;

an input terminal, which is electrically connected to the circuit board and extends from the terminal outlet;

a separation mechanism, which includes a motor, a screw, a nut slider, and at least one push rod; the motor is limited or fixed in the accommodation chamber, and is electrically connected to the circuit board; the motor drives the screw to rotate, the nut slider is caused to move in a straight line along the screw; the push rod is directly or indirectly connected to the nut slider, and extends or disappears from the through holes.

In some embodiments of the present disclosure, the shell component is provided with a sliding groove or a sliding hole that is compatible with the push rod.

In some embodiments of the present disclosure, the through holes are symmetrically or circularly arranged around the terminal outlet, and the push rod corresponds to the through holes and is directly or indirectly connected to the nut slider.

In some embodiments of the present disclosure, the nut slider includes an upper nut slider and a lower nut slider, and the upper nut slider is detachably connected to the lower nut slider to form a complete ring-shape and wrap around the screw rod.

In some embodiments of the present disclosure, the push rod is connected or fixedly connected to the upper nut slider and/or the lower nut slider as a whole.

In some embodiments of the present disclosure, an installation hole is provided in a middle of the circuit board, and the motor is provided in the installation hole.

In some embodiments of the present disclosure, each of two sides of the motor is provided with one limit plate, and limit slots that are compatible with the limit plates are provided inside the shell component.

In some embodiments of the present disclosure, the charging state detection circuit includes at least one of an output voltage detection circuit, an output current detection circuit, a temperature detection circuit, an overvoltage detection circuit, an overcurrent detection circuit, a short circuit detection circuit, a reverse connection detection circuit, and a communication protocol detection circuit.

In some embodiments of the present disclosure, the input terminal includes one of two flat plugs, three flat plugs, two round plugs, three round plugs, three square plugs, and a USB TYPE-C male head.

In some embodiments of the present disclosure, it further includes an output terminal, and the output terminal is arranged away from one surface where the input terminal is located and is electrically connected to the circuit board.

The beneficial effect of the present disclosure is that when the charging state detection circuit on the circuit board detects an abnormal state, it sends an electrical signal to drive the motor to operate. The motor drives the screw to rotate, the nut slider is caused to move in a straight line along the screw, thereby causing the push rod connected to the nut slider to move in a straight line and extend from the through holes. The push rod contacts an external object, and the shell component is caused to retreat, thereby disconnecting the input terminal from the electrical connection and achieving physical power-off. Besides that, the screws and nut sliders are used to run smoothly, with controllable force, and will not cause damage to items.

### BRIEF DESCRIPTION OF DRAWINGS

FIG. 1 is a sectional structure schematic diagram of an overcharge protection device according to an embodiment by the present disclosure.

FIG. 2 is an external structure schematic diagram of the overcharge protection device according to the embodiment by the present disclosure.

FIG. 3 is a decomposition structure schematic diagram of the overcharge protection device according to the embodiment of by the present disclosure.

FIG. 4 is a decomposition structure schematic diagram of the overcharge protection device in another direction according to the embodiment by the present disclosure.

FIG. 5 is a structural schematic diagram of an overcharge protection device according to another embodiment by the present disclosure.

FIG. 6 is a decomposition structure schematic diagram of a separation mechanism of the overcharge protection device according to the another embodiment by the present disclosure.

FIG. 7 is a circuit module schematic diagram of an overcharge protection device according to a still one embodiment by the present disclosure.

FIGS. 8A, 8B and 8C are circuit schematic circuit diagrams of the overcharge protection device according to the still one embodiment by the present disclosure.

Numeral reference: 100- shell component, 110- accommodation chamber, 120- terminal outlet, 130- through hole, 131- sliding hole, 140- limit slot, 150- transparent area, 200-circuit board, 210- installation hole, 220- voltage detection module, 230- current detection module, 240- power management module, 250- main control module, 260- motor drive module, 270- state indication module, 300- input terminal, 400- separation mechanism, 410- motor, 411- limit plate, 420- screw, 430- nut slider, 431- upper nut slider, 432- lower nut slider, 440- push rod, 441- avoidance notch, 442- extension rod, 500- output terminal, 600- indicator light, 700- power switch button, 710- keycap.

### DESCRIPTION OF EMBODIMENTS

In order to further clarify the purpose, technical solution, and advantages of the present disclosure, the following will provide a detailed explanation of the present disclosure in combination with the accompanying drawings and embodiments. It should be understood that specific embodiments described herein are only used to explain the present disclosure and are not intended to limit the present disclosure.

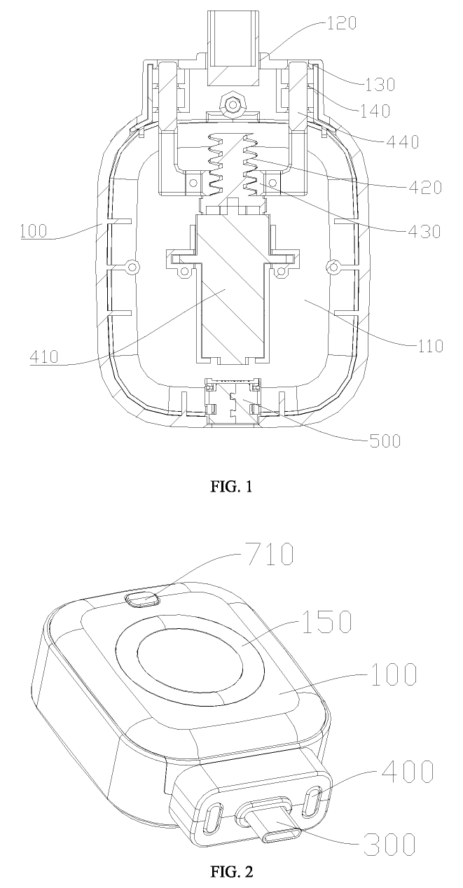

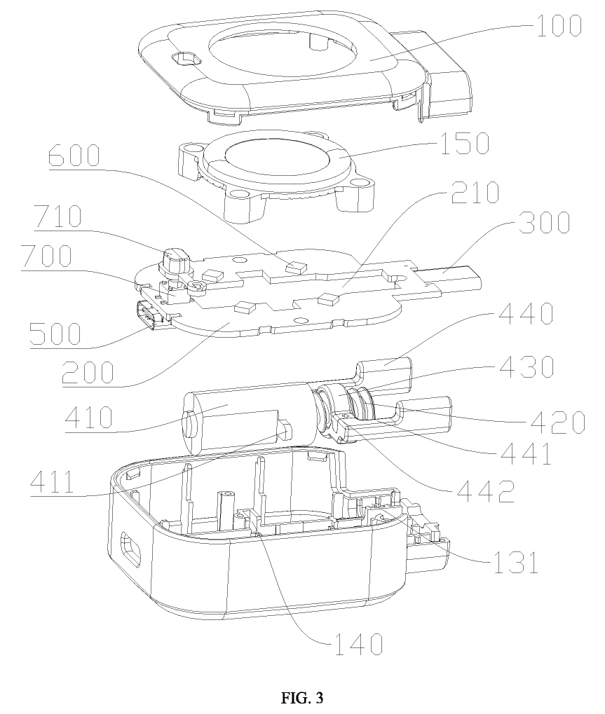

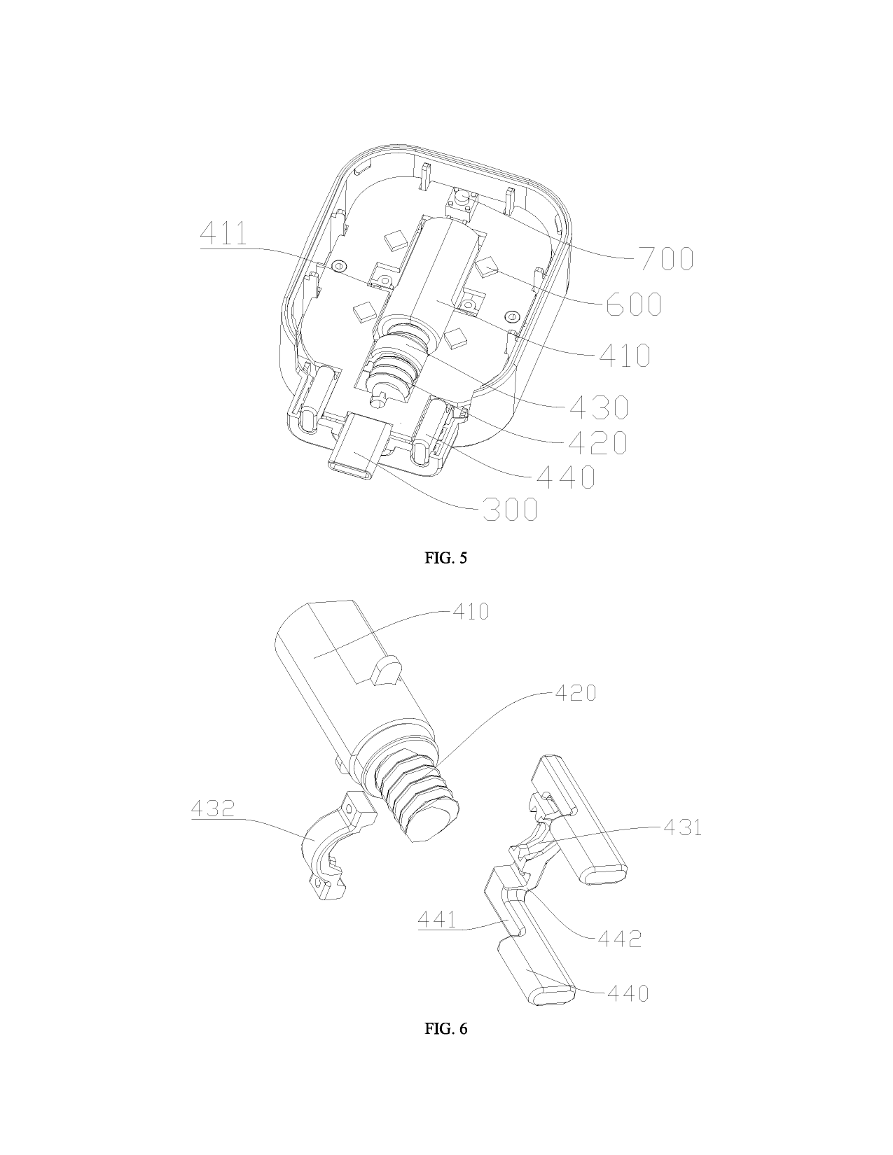

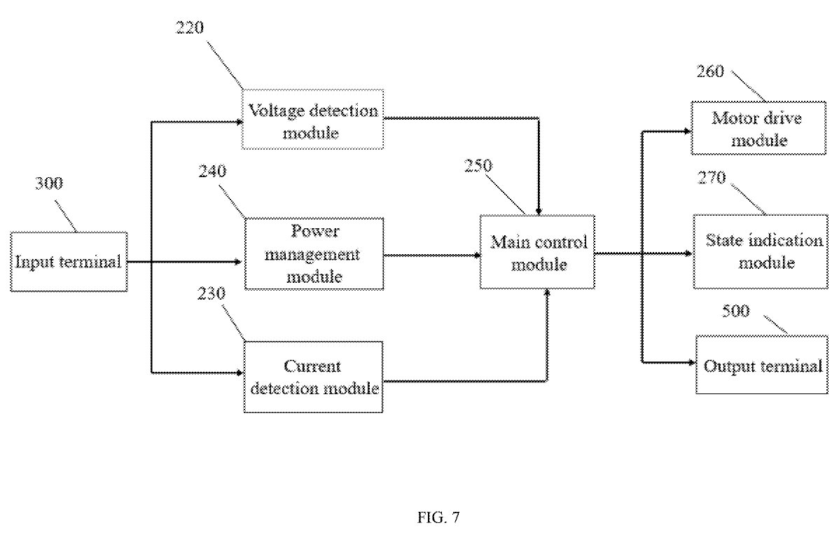

Referring to FIGS. 1-7, 8A, 8B and 8C, an overcharge protection device includes:

a shell component 100, which has an accommodation chamber 110 inside, and a terminal outlet 120 is further provided on the shell component 100, at least two through holes 130 that communicate with the accommodation chamber 110 are provided on one side where the terminal outlet 120 is located;

a circuit board 200, which is provided inside the accommodation chamber 110, and integrated with a charging circuit and a charging state detection circuit;

an input terminal 300, which is electrically connected to the circuit board 200 and extends from the terminal outlet 120;

a separation mechanism 400, which includes a motor 410, a screw 420, a nut slider 430, and at least one push rod 440; the motor 410 is limited or fixed in the accommodation chamber 110, and is electrically connected to the circuit board 200; the motor 410 drives the screw 420 to rotate, the nut slider 430 is caused to move in a straight line along the screw 420; the push rod 440 is directly or indirectly connected to the nut slider 430, and extends or disappears from the through holes 130;

when the charging state detection circuit on the circuit board 200 detects an abnormal state, it sends an electrical signal to drive the motor 410 to run; the motor 410 drives the screw 420 to rotate, and the nut slider 430 is caused to move in a straight line along the screw 420, thereby causing the push rod 440 connected to the nut slider 430 to move in a straight line and extend from the through holes 130, the push rod 440 contacts an external object, and the shell component 100 is caused to retreat, thereby disconnecting the input terminal 300 from the electrical connection and achieving physical power-off; besides that, the screw 420 and the nut slider 430 are used to ensure smooth operation, with controllable force, and will not cause damage to the object.

Referring to FIGS. 1-5, the shell component 100 is provided with a sliding groove or a sliding hole 131 that is compatible with the push rod 44, thereby improving the stability of the extension and retraction of the push rod 440 to avoid positional deviation. It can be understood that the through holes 130 themselves form a fit with the push rod 440, thereby providing the sliding groove and the sliding hole 131 is only for enhancement. At the same time, the through holes 130, the sliding groove, or the sliding hole 131 can prevent the nut slider 430 (upper nut slider 431 and lower nut slider 432) from rotating.

In an implementation mode of the present disclosure, the through holes 130 are symmetrically or circularly arranged around the terminal outlet 120, and the push rod 440 corresponds to the through holes 130 and is directly or indirectly connected to the nut slider 430. Thus, the shell component 100 is caused to stably retreat in a straight line, thereby avoiding the input terminal 300 from being offset and getting stuck.

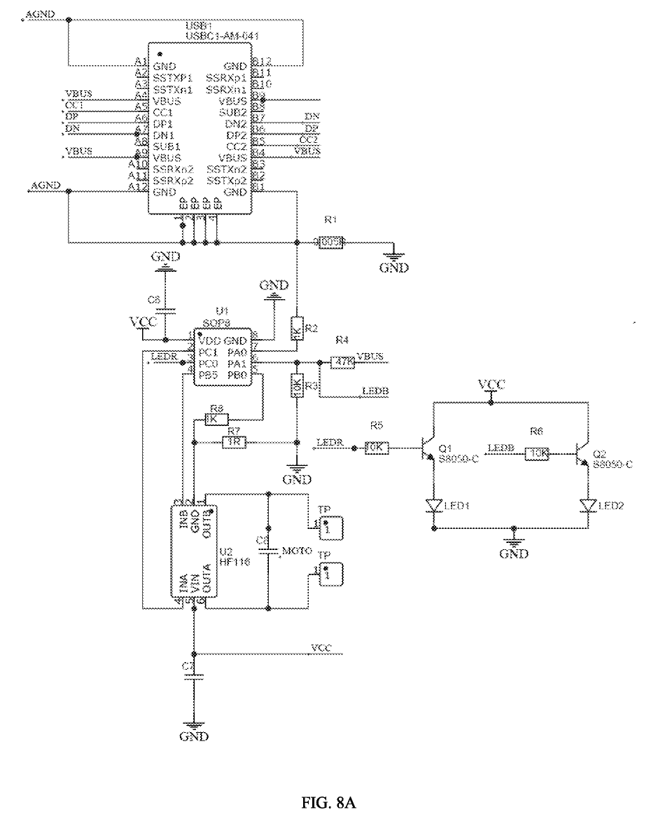

Referring to FIG. 6, the nut slider 430 includes an upper nut slider 431 and a lower nut slider 432. The upper nut slider 431 and the lower nut slider 432 are detachably connected to form a complete ring-shape and wrap around the screw rod. It can be understood that the nut slider 430 is provided with internal threads that are compatible with the screw 420, and the upper nut slider 431 and the lower nut slider 432 each have half of the threads. It can be understood that the screw nut pair of this application does not require high precision and uses a simple screw 420 and a simple nut slider 430, which not only has low cost but is also easy to install. It is simple to install and can also use high-precision screw nut pairs as needed.

Referring to FIG. 6, the push rod 440 is connected or fixedly connected as a whole with the upper nut slider 431 and/or the lower nut slider 432. Adopting an integrated design can reduce installation steps and the installation is simple; the connection can be achieved through extension arms or extension plates.

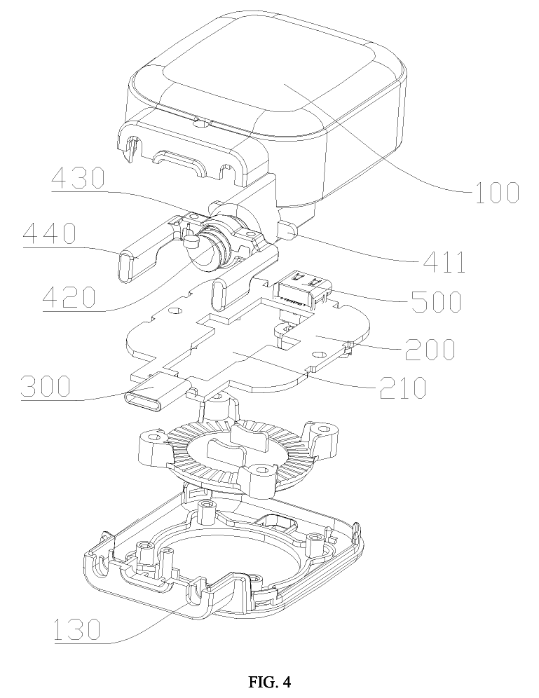

Referring to FIGS. 3-5, there is an installation hole 210 in a middle of the circuit board 200, and the motor 410 is provided inside the installation hole 210. Usually, the installation hole 210 accommodates both the motor 410 and the screw, and the push rod 440 can be located above/below the circuit board 200.

Referring to FIGS. 3-5, two sides of the motor 410 are respectively provided with one limit plate 411, and limit slots 140 that are compatible with the limit plates 411 are provided inside the shell component 100. Providing the limit plates 411 and the limit slots 140 can prevent the push rod 440 from extending and causing the motor 410 to move along when the shell component 100 retracts.

In an implementation mode of the present disclosure, the charging state detection circuit includes at least one of an output voltage detection circuit, an output current detection circuit, a temperature detection circuit, an overvoltage detection circuit, an overcurrent detection circuit, a short circuit detection circuit, a reverse connection detection circuit, and a communication protocol detection circuit.

In an implementation mode of the present disclosure, the input terminal 300 includes one of two flat plugs, three flat plugs, two round plugs, three round plugs, three square plugs, or USB TYPE-C male plugs.

Referring to FIG. 1, an output terminal 500 is further provided. The output terminal 500 is arranged away from the input terminal 300 and is electrically connected to the circuit board 200. In an implementation mode, the output terminal 500 uses a USBTYPE-C female socket.

In an implementation mode of the present disclosure, the push rod 440 is provided with an avoidance notch 441, and the avoidance notch 441 accommodates a part of the circuit board 200 to facilitate a center of a protruding part of the push rod 440 to be symmetrically or circularly arranged around the input terminal 300.

It can be understood that after the push rod 440 is fully extended, it automatically resets, that is, the motor 410 reverses, the upper nut slider 431 and the lower nut slider 432 are caused to retreat along the screw, thereby driving the push rod 440 to retract. It can be understood that a stroke of the push rod 440 is greater than an extension length of the input terminal 300.

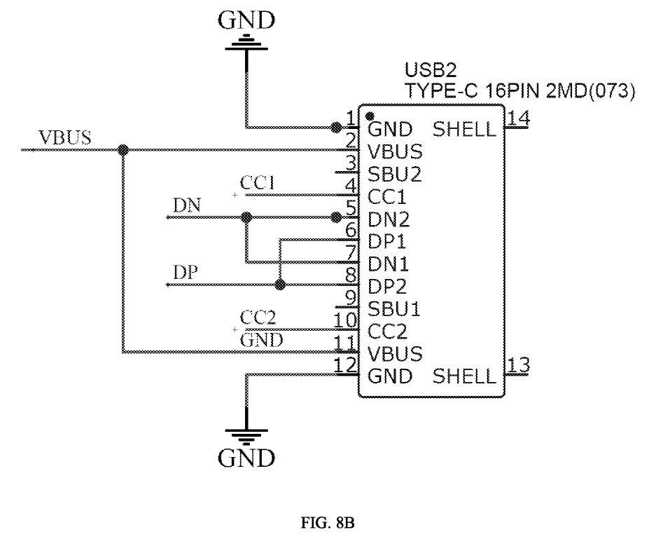

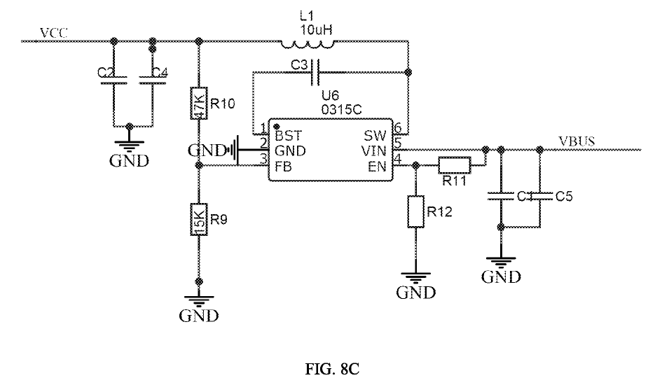

Referring to FIGS. 7, 8A, 8B and 8C, the circuit board 200 includes an input interface (the input terminal 300), a voltage detection module 220, a current detection module 230, a power management module 240, a main control module 250, a motor drive module 260, a state indication module 270, and an output interface. The charging circuit is composed of the input interface, the main control module 250, and the output interface (the output terminal 500). The voltage detection module 220 and the current detection module 230 form the charging state detection circuit. The power management module 240 adopts a 0315C series power management chip, combined with an inductor L1, filtering capacitors C2, C3, C4, C5, and feedback voltage divider resistors R9, R10 to form a boost/stabilize topology. The charging state detection circuit includes a Voltage Bus, (VBUS) current detection circuit (R1) and voltage detection circuits (R2, R3). The motor drive module 260 is mainly responsible for the drive chip U2. The Microcontroller Unit, (MCU) (i.e. U1) monitors the VBUS voltage and current state in real-time. When overvoltage, undervoltage, or overcurrent faults are detected, the protection logic triggered to start the motor 410 and turn on a fault indicator light. It can be understood that the state indicator module 270 is connected to a plurality of indicator lights 600, and the indicator lights 600 indicate different states through different colors. It can be understood that the shell component 100 has a transparent area 150 configured for light to pass through.

In an implementation mode of the present disclosure, it also includes a power switch button 700, and the power switch button 700 is electrically connected to the circuit board 200. When plugged in, it defaults to normal charging. When the current is less than 500mA/h, the circuit board 200 drives the motor 410 to automatically push out the push rod 440 for power-off protection. The power switch button 700 is pressed to switch to low-power charging. If the current is less than 100mA/h, the circuit board 200 will drive the motor 410 to automatically push out the push rod 440 for power-off protection. The colors of the two charging indicator lights 600 are different. High power charging displays a blue light, low-power charging displays a green light, and the red-light flashes when there is a physical power-off. It can be understood that the power switch button 700 usually includes a keycap 710, and the keycap 710 is exposed or protrudes from the shell component 100.

It should be noted that if directional indications (such as up, down, left, right, front, back, etc.) are involved in the embodiments of the present disclosure, the directional indications are only used to explain the relative position relationship and motion of the components in a specific posture (as shown in the attached figure). If the specific posture changes, the directional indications will also change accordingly.

In addition, if there are descriptions related to “first”, “second”, etc. in the embodiments of the present disclosure, the descriptions of “first”, “second”, etc. are only for descriptive purposes and cannot be understood as indicating or implying their relative importance or implying the number of technical features indicated. Therefore, the features that are limited to “first” and “second” can explicitly or implicitly include at least one of these features.

In summary, the present disclosure provides an overcharge protection device that, when the charging state detection circuit on the circuit board detects an abnormal state, it sends an electrical signal to drive the motor to operate. The motor drives the screw to rotate, the nut slider is caused to move in a straight line along the screw, thereby causing the push rod connected to the nut slider to move in a straight line and extend from the through holes. The push rod contacts an external object, the shell component is caused to retract, thereby disconnecting the input terminal from the electrical connection and achieving physical power-off. Besides that, the screws and nut sliders are used to ensure smooth operation, with controllable force, and will not cause damage to the object.

The above description is only preferred embodiments of the present disclosure and does not limit the present disclosure in any form. Although the present disclosure has been

disclosed in the preferred embodiment, it is not intended to limit the present disclosure. Those skilled in the art can use the disclosed technical content to make slight changes or modifications to equivalent embodiments without departing from the scope of the technical solution of the present disclosure. Any simple modifications, equivalent changes, and modifications made to the above embodiments based on the technical essence of the present disclosure without departing from the technical solution of the present disclosure still belong to the scope of the technical solution of the present disclosure.

What is claimed is:

1. An overcharge protection device, comprising:
a shell component, which has an accommodation chamber inside, and a terminal outlet is further provided on the shell component, at least two through holes that communicate with the accommodation chamber are provided on one side where the terminal outlet is located;
a circuit board, which is provided inside the accommodation chamber, and integrated with a charging circuit and a charging state detection circuit;
an input terminal, which is electrically connected to the circuit board and extends from the terminal outlet;
a separation mechanism, which includes a motor, a screw, a nut slider, and at least one push rod; the motor is limited or fixed in the accommodation chamber, and is electrically connected to the circuit board; the motor drives the screw to rotate, the nut slider is caused to move in a straight line along the screw; the push rod is directly or indirectly connected to the nut slider, and extends or disappears from the through holes.

2. The overcharge protection device according to claim 1, wherein the shell component is provided with a sliding groove or a sliding hole that is compatible with the push rod.

3. The overcharge protection device according to claim 1, wherein the through holes are symmetrically or circularly arranged around the terminal outlet, and the push rod corresponds to the through holes and is directly or indirectly connected to the nut slider.

4. The overcharge protection device according to claim 1, wherein the nut slider comprises an upper nut slider and a lower nut slider, and the upper nut slider is detachably connected to the lower nut slider to form a complete ring-shape and wrap around the screw rod.

5. The overcharge protection device according to claim 4, wherein the push rod is connected or fixedly connected to the upper nut slider and/or the lower nut slider as a whole.

6. The overcharge protection device according to claim 1, wherein an installation hole is provided in a middle of the circuit board, and the motor is provided in the installation hole.

7. The overcharge protection device according to claim 1, wherein each of two sides of the motor is provided with one limit plate, and limit slots that are compatible with the limit plates are provided inside the shell component.

8. The overcharge protection device according to claim 1, wherein the charging state detection circuit comprises at least one of an output voltage detection circuit, an output current detection circuit, a temperature detection circuit, an overvoltage detection circuit, an overcurrent detection circuit, a short circuit detection circuit, a reverse connection detection circuit, and a communication protocol detection circuit.

9. The overcharge protection device according to claim 1, wherein the input terminal comprises one of two flat plugs, three flat plugs, two round plugs, three round plugs, three square plugs, and a USB TYPE-C male head.

10. The overcharge protection device according to claim 1, wherein it further comprises an output terminal, and the output terminal is arranged away from one surface where the input terminal is located and is electrically connected to the circuit board.
